(19) United States
(12) Patent Application Publication
(10) Pub. No.: US 2026/0004331 A1
(43) Pub. Date: Jan. 1, 2026

(54) NEIGHBORHOOD-CENTRIC E-COMMERCE ONLINE MARKETPLACE SEARCH

(71) Applicant: KewlStreet LLC, New York, NY (US)

(72) Inventor: Eldon Scott, New York, NY (US)

(21) Appl. No.: 19/251,577

(22) Filed: Jun. 26, 2025

Related U.S. Application Data
(60) Provisional application No. 63/664,495, filed on Jun. 26, 2024.

(51) Int. Cl. G06Q 30/0601; G06Q 40/04

(52) U.S. Cl. CPC G06Q 30/0625; G06Q 30/0641; G06Q 40/04

(57) ABSTRACT

A geocentric platform may receive a request to initiate an exchange with an agent device associated with an agent account registered with the geocentric platform. The request may include one or more objects. The geocentric platform may query at least one database for data associated with the one or more objects, then may identify one or more agent devices associated with the one or more objects. The geocentric platform may then initiate the exchange between the user device and the one or more agent devices. The exchange may include a request to allocate the one or more objects to the user device. The geocentric platform may then determine a resource to allocate the user device. The resource may be based on the exchange between the user device and the one or more agent devices. The geocentric platform may transmit the resource to the user device.

### CROSS-REFERENCE TO RELATED APPLICATIONS

The present patent application claims the priority benefit of U.S. Provisional Patent Application No. 63/664,495, filed Jun. 26, 2024 and entitled “Neighborhood-Centric e-Commerce Online Marketplace Search,” the disclosure of which is incorporated by reference herein in its entirety.

### BACKGROUND OF THE INVENTION

### 1. Field of the Disclosure

The present disclosure is generally related to a geocentric user application and more particularly relating to incorporating geographic location when interacting with the geocentric user application to perform neighborhood-centric online searches.

### 2. Description of the Related Art

Small, community-oriented businesses face several disadvantages when forced to compete with e-commerce businesses, particularly when they provide equivalent or similar products or services. Despite the convenience of locally available products and services, online e-commerce platforms typically have more resources, diverse product offerings, lower prices, etc. This is often reinforced by global presence and brands which provide more efficient economies of scale and negotiating power.

Larger e-commerce businesses are further better positioned and resourced with respect to their online platforms that digitally advertise and market their products, with budgets allowing for sponsorships and preferred advertising with various platforms (e.g., social media, sports partnerships, etc.). Likewise, their scale and relationships often provide customer data and analytics which provide a distinct advantage when making business decisions and in tailoring their marketing strategies to capture market share. In an increasingly digital oriented world, small, local businesses which may have limited to no online presence can often be overlooked, particularly by tourists, despite the advantage of local geography. Likewise, they often struggle to capture local business. This often results in a customer's needs being satisfied by a large e-commerce business before considering a local agent.

There is, therefore, a need in the art for improved systems and methods of incorporating geographic location when interacting with the geocentric user application to perform neighborhood-centric online searches.

### SUMMARY OF THE CLAIMED INVENTION

The method for operating a geocentric platform may include receiving, from a user device associated with a user account registered with the geocentric platform, a request to initiate an exchange. The exchange may be with an agent device associated with an agent account registered with the geocentric platform. The request may include one or more objects. The method may further include querying at least a local database and an external database for data associated with the one or more objects. The geocentric platform may identify one or more agent devices associated with the one or more objects. The one or more agent devices are configured to provide the one or more objects to the user device. The geocentric platform may then initiate the exchange between the user device and the one or more agent devices. The exchange may include a request to allocate the one or more objects to the user device. The geocentric platform may complete the exchange between the user device and the agent device. The geocentric platform may then determine a resource to allocate the user device based on a predetermined allocation schedule stored in a respective database. The resource may be based on the exchange between the user device and the one or more agent devices. The geocentric platform may transmit the resource to the user device.

Systems and methods are described herein for operating a geocentric platform. The systems include one or more processors and a non-transitory computer-readable storage medium storing instructions that, when executed by the one or more processors, cause the one or more processors to perform any of the methods as previously described.

A non-transitory computer-readable medium described herein may store instructions which, when executed by one or more processors, cause the one or more processors to perform any of the methods as previously described.

These illustrative examples are mentioned not to limit or define the disclosure, by the aid understanding thereof. Additional embodiments are discussed in the Detailed Descriptions, and further description is provided there.

### BRIEF DESCRIPTION OF THE DRAWINGS

FIG. 1 illustrates a block diagram of a geocentric platform according to some aspects of the present disclosure.

FIG. 2 illustrates a block diagram of an aggregation database of the geocentric platform according to some aspects of the present disclosure.

FIG. 3 illustrates a block diagram of a discovery database of the geocentric platform according to some aspects of the present disclosure.

FIG. 4 illustrates a block diagram of a fulfillment database of the geocentric platform according to some aspects of the present disclosure.

FIG. 5 illustrates a flow chart of the functionality of the geocentric platform according to some aspects of the present disclosure.

FIG. 6 illustrates a block diagram of a computing system capable of executing the functionality of the geocentric platform according to some aspects of the present disclosure.

### DETAILED DESCRIPTION

Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples.

This is a system for a geocentric platform. The geocentric platform can operate as a resource to users (e.g., customers or consumers) to identify agents for obtaining specific goods or services within a certain geographic location (e.g., a neighborhood). The geocentric platform includes a network of accounts registered with the geocentric platform that are associated with users, customers, agents, promotors, any combination thereof, or the like. The network of accounts may interact to facilitate exchanges between accounts (e.g., between a user and an agent). In some examples, the network of accounts may include internal associations that are stored in a database of the geocentric platform. For example, a promotor account may be associated with one or more agent accounts, an agent account may be associated with one or more user accounts, etc.

This system comprises of a geocentric platform 102 that is a software program, typically accessible via the internet, and which may optionally be located on a cloud 118, which hosts ecommerce functionality for one or more agent devices within a common geographic location. A geocentric platform 102 may service a plurality of geographic locations which may also be referred to as neighborhoods. The geocentric platform 102 may include one or more components that are configured to perform the functionality of the geocentric platform 102, including, but not limited to, a product database 104, an incentive database 106, and an object manager 108. Further, the object manager 108 may include additional internal components and/or modules, such as an aggregation database 110, a discovery database 112, a fulfillment database 114, and an incentive manager 116.

The product database 104 stores product data and associations of products with agent devices. The products may be associated with one or more of a third-party agent device and a local agent device. When associated with both a third-party agent device and a local agent device, the local agent device is a local sponsor agent device. The product database 104 is populated by the aggregation database 110 and is used by the discovery database 112 and the fulfillment database 114. The product database 104 may further be populated by a third-party network 120 and updated by a geocentric platform 102. For example, the product database 104 may include data similar to TABLE I.

TABLE I
Product Database 104

| Product | | | |
|---|---|---|---|
| ID | Product Description | Vendor | Local Vendor |
| 1234 | Slotted Wooden Spoon | Cook's Corner | Cook's Corner |
| 2345 | Paring Knife | CutleryKing | Cook's Corner |
| 3456 | Child's Car Seat | SafeJourney | SafeJourney |
| 4567 | Stainless Steel Cookware | Gourmet | Cook's Corner |
| | | Essentials | |
| 5678 | 10-Pack LED Light Bulbs | BrightLife | HomeGlow |
| 6789 | Bluetooth Running | SoundWave | TechTrend |
| | Headphones | | |
| 7890 | Organic Cotton Bath | EcoComfort | HomeGlow |
| | Towels | | |
| 8901 | Waterproof Hiking | Adventure Gear | OutdoorFitters |
| | Backpack | | |

The incentive database 106 stores data related to incentives, such as types of incentives, qualification criteria which must be satisfied to earn the incentives and may further comprise customer data comprising incentives earned and/or progress towards one or more incentives. The incentive database 106 may further comprise promoter incentive data. The incentive database 106 may be populated by the administrator of a geocentric platform 102, users of a geocentric platform 102 including local agent devices, and the incentive manager 116. The incentive database 106 is used by the incentive manager 116 and may further be used by the discovery database 112 when completing an exchange to redeem earned incentives. For example, incentive database 106 may include data similar to TABLE II.

TABLE II
Incentive Database 106

| Incentive | Criteria |
|---|---|
| 15% Discount | Spend over $100 in a transaction |
| Rewards Points | Earn 1 point per $1 spent |
| Cash Back | 1% cash back on all purchases |
| Complimentary Gift | Purchase any 3 items from |
| | participating vendors |
| Birthday Discount | Provide date of birth upon account |
| | creation for annual offer |
| Bonus Product | Buy one, get one free on select |
| with Purchase | products |

As mentioned above, the object manager 108 may include one or more components configured to perform the operations of the object manager 108, including, but not limited to, aggregation database 110, discovery database 112, fulfillment database 114, and incentive manager 116. For example, the object manager 108 may initiate the aggregation database 110, which associates products from non-local third-party agent devices with local sponsor agent devices and populates the product database 104 with the products and agent device associations. In response to receipt of the product and agent device associations, the discovery database 112 is initiated, which allows a customer to search for and add products to an order and to complete an exchange. The exchange is received and the fulfillment database 114 is initiated which identifies the agent device to fulfill each ordered product and then collects the ordered products. The ordered products are received and the incentive manager 116 is initiated which uses the exchange data and the incentive database 106 to determine an incentive for which the customer qualifies. The incentive is received, and the customer is notified of their order status and earned incentive.

The aggregation database 110 queries one or more third-party database 122 for products offered for sale by one or more third-party agent devices. For each product, a local sponsor agent device from within the neighborhood is selected and is associated with the product which is then saved to the product database 104. The process is repeated for all products within the third-party databases 122 and may additionally include products that are not in the third-party databases 122 but are offered by the local agent devices. The product data is sent to the object manager 108, which may include product data including agent device associations from the aggregation database 110.

The discovery database 112 receives a product query from a user device and queries a product database 104 for one or more products and/or services matching the product query. The products are displayed to the customer on an interactive user interface of a user device, and one or more products are selected according to input on the interactive user interface of the user device (e.g., via a touchscreen, a mouse, a keyboard, a microphone, etc.) and added to an order. If the order is not complete, then an additional product query is received and the process of searching for and selecting a product repeats. The process of receiving product queries, querying the product database, displaying products, and selecting products may be repeated in part or in full multiple times until the order is complete. An incomplete search and selection process may comprise searching for a product, but not selecting a product before another product query is received. When the order is complete, an exchange is completed such that the customer agrees to purchase the products and may further comprise a financial exchange where a payment method is provided by the customer and the exchange amount is received via the provided payment method. Completing the exchange may further comprise a financial exchange of funds or credit from a customer's financial service to one or more agents' accounts. The exchange data is sent to the object manager 108.

The fulfillment database 114 receives exchange data (e.g., from the object manager 108) for each product included in the exchange. The fulfillment database 114 may query the product database 104 for a product matching the selected product and an agent device is selected to fulfill the ordered product. The product is collected from the agent device and the process is repeated for all products included in the exchange. For products which are not in the inventory of a local agent device, the products may be acquired from a third-party agent device via a local sponsor agent device. When all products have been collected, the collected products are sent to the object manager 108. The object manager 108 may receive the products from the fulfillment module 410 and initiate the incentive manager 116.

The incentive manager 116 receives exchange data and queries the incentive database 106 for data relating to incentives for which the customer may qualify based on the exchange data. The exchange data may comprise a total exchange amount for products ordered by a customer. For example, the exchange data may comprise two items: a slotted wooden spoon, and a paring knife. In some embodiments, the exchange may involve a single agent device providing all the ordered products. In other embodiments, the exchange may involve multiple agent devices. In embodiments where an exchange involved multiple agent devices, additional exchange data may be required, such as exchange amounts for products purchased from each agent device, or an invoice of all products ordered and their respective agent devices.

The incentive manager 116 may query the incentive database 106 for data relating to incentives which may be due to a customer. Examples of data may include rewards, incentive qualifications, and may include customers' progress towards incentive qualifications. Incentives may be monetary, discounts, refunds, rebates, or may provide access to limited access products, services, events, entries for games of chance, etc.

The incentive manager 116 may determine an incentive due to the customer. In some embodiments, incentives may comprise a discount on future exchanges. In other embodiments, incentives may comprise reward points or cash back which may be used towards future purchases via the geocentric platform 102 or one or more of the local agent devices within the neighborhood. The incentives may also be contributed towards local non-profit organizations and may earn additional rewards. In an embodiment, selecting an incentive of one point per dollar spent rounded to the nearest whole dollar, where each 100 points has a cash equivalent value of one dollar. The earned points may be redeemed towards future purchases or as a donation to a local non-profit organization. Such organizations may include charities, community organizations, educational and/or athletic programs, etc.

In some embodiments, multiple embodiments may be determined. For example, incentives may be provided at the level of the geocentric platform 102 for incentives which may be redeemed at any participating agent device and/or local organization. Additionally, agent-specific incentives may be determined which may be redeemable only at specific agents. Likewise, some incentives may be part of a campaign or promotion which may be redeemable only during a limited period of time. In some embodiments, incentives may be subject to an expiration date and/or criteria. In such embodiments, expiring incentives, such as reward points, may have a default use specified, such as donation to a customer's non-profit of choice, instead of allowing the incentive to expire without redemption. In some embodiments, incentives may additionally be determined for one or more promoters who may have contributed to the exchange, such as by registering one or more of the involved agent devices, promotion of a campaign which the exchange was a part of, and/or the redemption of a coupon, coupon code, affiliate code, etc. by the customer which is associated with a promoter.

In some embodiments, no incentives or rewards are determined to which a customer and/or promoter qualify, and instead, determine the progress toward an incentive. For example, if an incentive of a five-dollar coupon is earned only when a cumulative $500 has been spent, and the customer has only spent $120 including the current exchange, the current progress of $120 of the $500 needed is determined. The incentive manager 116 may transmit the determined incentive(s) to the incentive database 106 for storage. In some embodiments, the data saved to the incentive database 106 may comprise progress towards a reward or incentive. The incentive manager 116 may transmit the incentive(s) to the object manager 108. An incentive is determined based upon the received exchange data which is saved to the incentive database 106. The geocentric platform 102 may notify the customer of their order status and any incentives they may have earned. In some embodiments, the order status may be that one or more products are ready to be picked up at one or more local agent devices. Alternatively, the order status may be that one or more products have been shipped, or alternatively may have been delivered. In some embodiments, an incentive may comprise reward points, cash back, a discount on a future purchase, etc. In other embodiments, the incentive may be progress earned towards an incentive if the customer does not qualify for an incentive based upon the current exchange.

A cloud 118 is a distributed network of computational and data storage resources which may be available via the internet or by a local network. The cloud 118 may be accessible via the internet is generally referred to as a public cloud whereas the cloud 118 on a local network is generally referred to as a private cloud. The cloud 118 may further be protected by encrypting data and requiring user authentication prior to accessing its resources. A third-party network 120 is comprised of one or more network resources owned by another party. For example, a third-party network 120 may refer to a non-local agent device who may be affiliated with, or whose products may be sponsored by a local agent within a neighborhood. In an embodiment, a third-party network may be Amazon.com and its associated resources. Third-party products sponsored by local agent devices may be offered for sale by the local agent devices via a geocentric platform 102, but may not be in the local agent device's inventory, but may instead be drop shipped, or purchased by the local agent device on a customer's behalf. Other examples of third-party networks may comprise marketing services, financial services including clearing houses and financial institutions. A third-party database 122 stores data owned by another party. For example, a third-party database 122 may store or access data on a third-party network 120, such as a non-local agent device's inventory. In an embodiment, a third-party database 122 may include online marketplaces such as Amazon, eBay, Newegg, etc. In some embodiments, a third-party database 122 may be operated and maintained by a manufacturer.

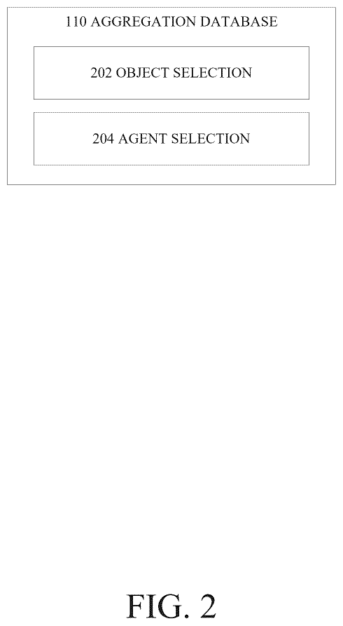

FIG. 2 illustrates a block diagram of an aggregation database of the geocentric platform according to some aspects of the present disclosure. One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

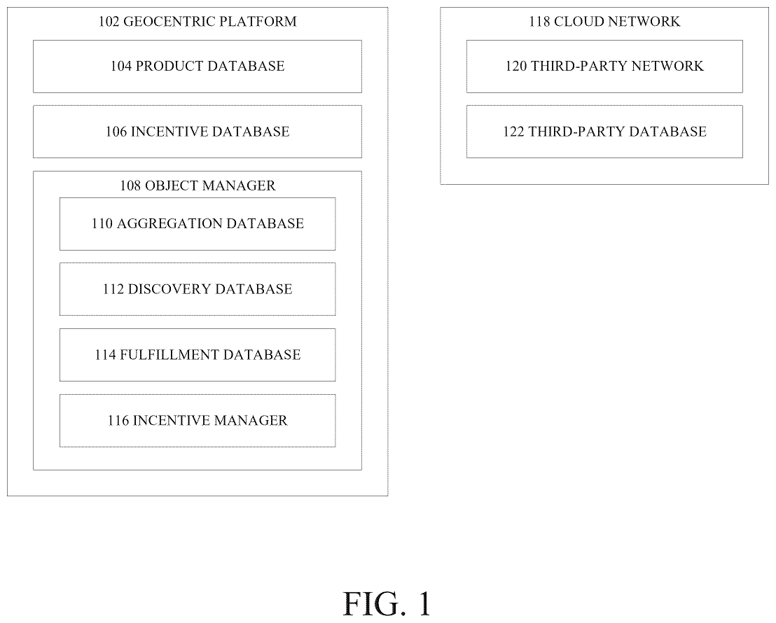

This figure displays the aggregation database 110. The process begins with the object selection 202 querying one or more third-party databases for products and/or services available for sale. Examples of third-party databases 122 (as described in FIG. 1) may include online marketplaces (e.g., Amazon, eBay, Newegg, etc.). In some embodiments, a third-party database 122 may be operated and maintained by a manufacturer. The object selection 202 may select a product from one or more third-party databases 122. For example, selecting a frying pan, a plunger, a child's car seat, etc. The agent selection 204 may select a sponsor agent device based on the selected product. A sponsor agent device may be a local agent device with a physical presence within a current neighborhood. The sponsor agent device may sell a similar or competing product or may have provided product information matching the third-party database 122 information including the specific agent device selling the product as indicated in the third-party database 122 data. In an embodiment, a household goods agent device may be selected as a sponsor of the selected frying pan. In another embodiment, a hardware store is selected as a sponsor of the selected plunger. In some embodiments, a product may not be matched to a selected agent device. For example, no agent devices within the neighborhood sell similar products nor have they indicated that they intend to sell such products. A list of such products may be available for agent devices to select, such as a child's car seat. In other embodiments, a sponsor may be selected based upon suitability to act as a sponsor. In other embodiments, a default agent device may be selected for all products which are otherwise without a local sponsor agent device. In further embodiments, no sponsor agent device is selected, and the products may be made available directly from a third-party network 120 agent device. In some embodiments, some local agent devices may have affiliate relationships with third-party network 120 agent devices and may therefore be provided priority in being selected. Such affiliate relationships may be limited to specific products and/or types of products. In some embodiments, multiple sponsor agent devices may be selected for the same products. Products may include services.

The aggregation database 110 may transmit the product data and the selected sponsor agent device to the product database 104 (as described in FIG. 1), which may save the product data and the selected sponsor agent device in association. The product data may comprise details relating to how such products may be fulfilled, such as whether the products will be acquired and stocked within the local sponsor agent device's physical store or inventory, or whether the products will be drop shipped, delivered to the local sponsor agent device's location upon order for receipt by a user device or alternatively shipped to the user device from the local sponsor agent device, etc. The aggregation database 110 may determine whether there are more products from the one or more queried third-party databases 122. If there are more products, the object selection 202 may select another product. For example, there are additional products which must be evaluated, and therefore selecting a child's car seat as the next product. In another embodiment, there are no additional products to evaluate. If there are no additional products to evaluate, the aggregation database 110 may transmit the product data including associations with selected local sponsor agent devices to the object manager 108.

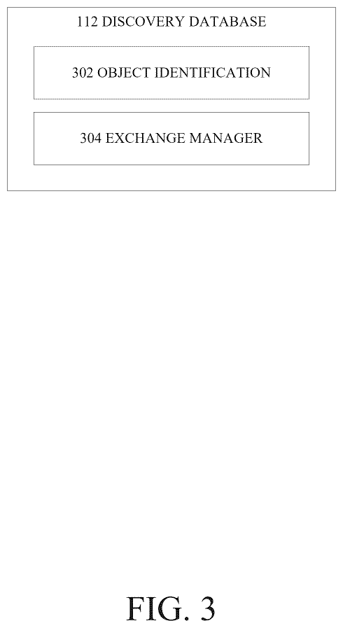

FIG. 3 illustrates a block diagram of a discovery database of the geocentric platform according to some aspects of the present disclosure. One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

The discovery database 112 may receive a product query from a user device. A product query may comprise at least a type of product or need. For example, products may include cooking utensils, pots and/or pans, furniture, portable speakers, clothing, gloves, cleaning supplies, etc. In other embodiments, a product query may comprise a need or problem, such as a “clogged toilet,” “broken window,” “no power to an electrical outlet,” “vehicle will not start,” etc. A product query may additionally comprise one or more filters which may include agent devices, size, cost, etc. The object identification 302 may query the product database 104 (as described in FIG. 1) for one or more products matching the received product query. In an embodiment, receiving products relating to cooking utensils including slotted spoons, knives, spatulas, etc. in response to a product query for cooking utensils. The object identification 302 may display the one or more products retrieved from the product database 104 matching the received product query (e.g., on a user interface of a user device associated with a customer). In an embodiment, displaying a plurality of products matching the description of cooking utensils including slotted spoons, knives, spatulas, etc. In some embodiments, the products may be ordered based upon most relevant products. In other embodiments, the products may be ordered according to alternate criteria such as price. The user device may select the method of ordering the products. Likewise, the user device may indicate the layout of how to display the products such as a list, tiles, etc. The user device may additionally select one or more filters to further modify the list of displayed products. The object identification 302 may receive input indicating selection of at least one product from the displayed products. In an embodiment, selecting a slotted wooden spoon, a paring knife, etc. The object identification 302 may determine whether the order is complete. The order may be complete if the user device does not submit an additional product query. In alternate embodiments, the order may be complete if the user device reviews the selected products and indicates that the order is complete such as by proceeding to provide and/or confirm billing and/or shipping information. If the order is complete, the exchange manager 304 may initiate an exchange which may comprise any or all of the steps of submitting one or more selected products and providing at least one payment method. A payment method may comprise an account number, credit card number, etc. In some embodiments, a payment method may comprise cash which may be exchanged in person when picking up a product in person or on delivery. An account number may be a bank account number and may additionally include a routing number. Some payment methods may utilize two factor authentication to authorize the purchase. The exchange may further require the submission of billing and/or shipping information including at least a name and address and may further include a phone number. Completion of an exchange comprises at least an acceptance by the geocentric platform 102 (as described in FIG. 1) and/or agent device of the selected products and/or services and payment method provided by the customer. Completion of the exchange may additionally comprise submission of the provided payment method information to a clearing house or other financial institution to process and confirm the exchange of funds. In some embodiments, additional fees such as shipping, taxes, etc. may be included in the exchange amount. In some embodiments, completion of an exchange may comprise completion of additional exchanges, such as for products not within the inventory of a local agent device which may be purchased from another agent device not within the local neighborhood. Completion of an exchange may additionally comprise the redemption of one or more incentives. Incentives may include one or more of, a discount, coupon code, reward points with a cash equivalence, etc. In some embodiments, incentives may be redeemed independently of an exchange. Independent redemption of incentives may include retroactive application of rewards towards a previous qualifying purchase or may comprise donation of an earned incentive to a non-profit organization. The exchange manager 304 may transmit exchange data to the object manager 108.

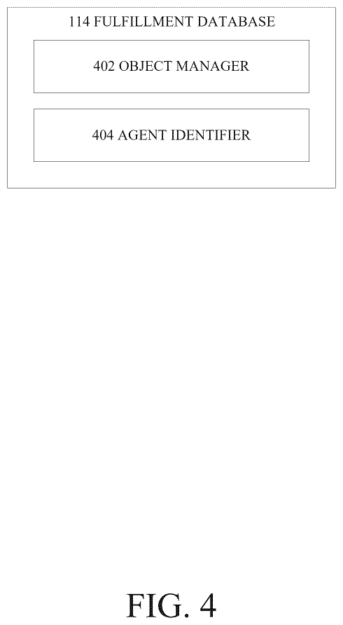

FIG. 4 illustrates a block diagram of a fulfillment database of the geocentric platform according to some aspects of the present disclosure. One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

The fulfillment database 114 may receive exchange data from the object manager 108 (as described in FIG. 1). The exchange data may comprise at least one or more products ordered by a user device. For example, the exchange data comprises two items, a slotted wooden spoon, and a paring knife. The object manager 402 may select a product which was ordered by a user device as indicated by the exchange data. In an embodiment, the selected product is a slotted wooden spoon. In another embodiment, the selected product is a paring knife. The object manager 402 may query the product database 104 for data relating to one or more products matching the selected product. In an embodiment, the data comprises an associated local sponsor agent device. In some embodiments, multiple local agent devices may be associated with the item. In some embodiments, the product may be located within one or more local agent devices' inventories. The agent identifier 404 may identify the local sponsor agent device associated with the product. In some embodiments, the products are available from a local agent device's inventory without requiring acquisition from a third-party agent device. In such embodiments, the local agent device with inventory may be selected. In other embodiments, the product is not available from a local agent device with inventory, therefore identifying a local agent device sponsor for a third-party agent device who offers the product for sale. In some embodiments, multiple local agent devices offer the same product for sale. In such instances, an algorithm may be applied or alternatively the user device may choose the agent device they want to fulfill the order. Algorithms may prioritize sale and fulfillment of products in inventory by local agent devices over local agent device sponsors of third-party agent devices. In such embodiments, third-party agent devices without local sponsor agent devices may have the lowest priority. In an embodiment, selecting a local home goods agent device to fulfill the slotted wooden spoon and paring knife as the slotted wooden spoon is in the local agent device's inventory and the paring knife is offered via a third-party seller for which the local home goods agent device is a sponsor agent device. In some embodiments, multiple agent devices may be identified to fulfill different items within a single exchange. The fulfillment database 114 may initiate the collection of the selected product from the identified agent device's inventory (e.g., sending an instruction to an employee device, sending an instruction to a fulfillment device, etc.). In embodiments where the selected product is not in the local agent device's inventory, the local agent device may acquire the product via a third-party agent device for whom they may be a sponsor agent device. In some embodiments, the product may be ordered directly from a third-party agent device. The product may be available for pickup from the one or more local agent devices by the user device or may alternatively be shipped to an address provided by the user device. In embodiments where the product is shipped to a user device, the product may be shipped from a single, local agent device, or may alternatively be sent directly from the selling agent device which may include directly from third-party agent devices. In some embodiments, multiple products may be available to the user device via different methods such as a product being available for local pickup and another product being delivered to an address provided by the user device. Similarly, different products may be available for pickup by or delivery to the user device at different times. The fulfillment database 114 may determine whether there are additional products within the exchange that must be fulfilled. If there are additional products which must be fulfilled in the exchange, the object manager 402 may select another product. If all of the products of the exchange have been fulfilled, the fulfillment database 114 transmits an indication of the fulfilled products within the exchange to the object manager 108.

The functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

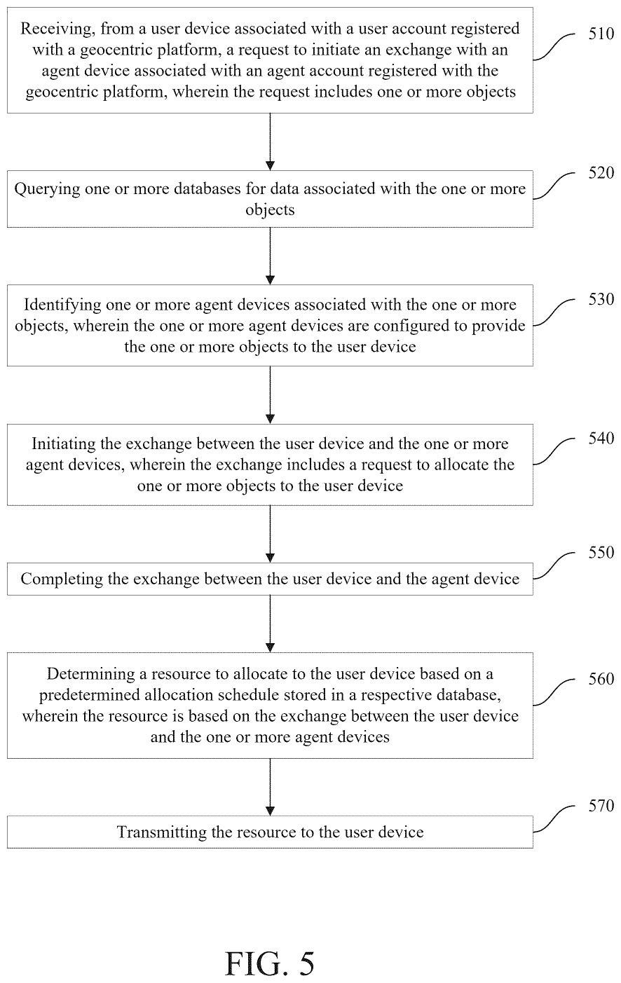

FIG. 5 illustrates a flow chart of the functionality of the geocentric platform according to some aspects of the present disclosure. The flow chart is not to be construed as limiting and instead is to provide an example for an implementation of the geocentric platform. For example, the steps discussed herein may be performed in a different order, in parallel, or some steps may be removed entirely.

At step 510, a geocentric platform receives, from a user device associated with a user account registered with a geocentric platform, a request to initiate an exchange with an agent device associated with an agent account registered with the geocentric platform, wherein the request includes one or more objects.

At step 520, the geocentric platform queries one or more databases for data associated with the one or more objects.

At step 530, the geocentric platform identifies one or more agent devices associated with the one or more objects, wherein the one or more agent devices are configured to provide the one or more objects to the user device.

At step 540, the geocentric platform initiates the exchange between the user device and the one or more agent devices, wherein the exchange includes a request to allocate the one or more objects to the user device.

At step 550, the geocentric platform completes the exchange between the user device and the agent device.

At step 560, the geocentric platform determines a resource to allocate to the user device based on a predetermined allocation schedule stored in a respective database, wherein the resource is based on the exchange between the user device and the one or more agent devices.

At step 570, the geocentric platform transmits the resource to the user device.

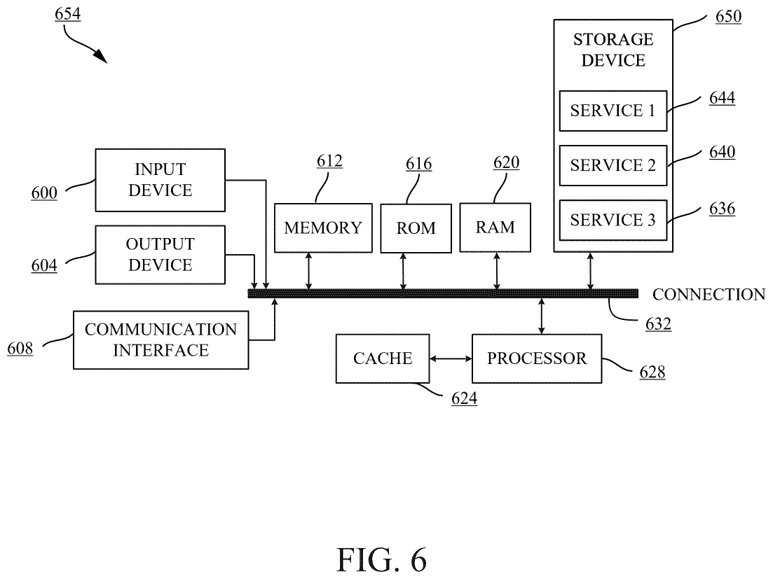

FIG. 6 illustrates an example computing device according to aspects of the present disclosure. For example, computing device 654 can implement any of the systems or methods described herein. In some instances, computing device 654 may be a component of or included within a media device. The components of computing device 654 are shown in electrical communication with each other using connection 632, such as a bus. The example computing device architecture 654 includes a processor (e.g., CPU, processor, or the like) 628 and connection 632 (e.g., such as a bus, or the like) that is configured to couple components of computing device 654 such as, but not limited to, memory 612, read only memory (ROM) 616, random access memory (RAM) 620, and/or storage device 650, to processing unit 628.

Computing device 654 can include a cache 624 of high-speed memory connected directly with, in close proximity to, or integrated within processor 628. Computing device 654 can copy data from memory 612 and/or storage device 650 to cache 624 for quicker access by processor 628. In this way, cache 624 may provide a performance boost that avoids delays while processor 628 waits for data. Alternatively, processor 628 may access data directly from memory 612, ROM 616, RAM 620, and/or storage device 650. Memory 612 can include multiple types of homogenous or heterogeneous memory (e.g., such as, but not limited to, magnetic, optical, solid-state, etc.).

Storage device 650 may include one or more non-transitory computer-readable media such as volatile and/or non-volatile memories. A non-transitory computer-readable medium can store instructions and/or data accessible by computing device 654. Non-transitory computer-readable media can include, but is not limited to magnetic cassettes, hard-disk drives (HDD), flash memory, solid state memory devices, digital versatile disks, cartridges, compact discs, random access memories (RAMs) 620, read only memory (ROM) 612, combinations thereof, or the like.

Storage device 650, may store one or more services, such as service 1 644, service 2 640, and service 3 636, that are executable by processor 628 and/or other electronic hardware. The one or more services include instructions executable by processor 628 to: perform operations such as any of the techniques, steps, processes, blocks, and/or operations described herein; control the operations of a device in communication with computing device 654; control the operations of processing unit 628 and/or any special-purpose processors; combinations therefor; or the like. Processor 628 may be a system on a chip (SOC) that includes one or more cores or processors, a bus, memories, clock, memory controller, cache, other processor components, and/or the like. A multi-core processor may be symmetric or asymmetric.

Computing device 654 may include one or more input devices 600 that may represent any number of input mechanisms, such as a microphone, a touch-sensitive screen for graphical input, keyboard, mouse, motion input, speech, media devices, sensors, combinations thereof, or the like. Computing device 654 may include one or more output devices 604 that output data to a user. Such output devices 604 may include, but are not limited to, a media device, projector, television, speakers, combinations thereof, or the like. In some instances, multimodal computing devices can enable a user to provide multiple types of input to communicate with computing device 654. Communications interface 608 may be configured to manage user input and computing device output. Communications interface 608 may also be configured to managing communications with remote devices (e.g., establishing connection, receiving/transmitting communications, etc.) over one or more communication protocols and/or over one or more communication media (e.g., wired, wireless, etc.).

Computing device 654 is not limited to the components as shown in FIG. 6. Computing device 654 may include other components not shown and/or components shown may be omitted.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored in a form that excludes carrier waves and/or electronic signals. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Some portions of this description describe examples in terms of algorithms and symbolic representations of operations on information. These operations, while described functionally, computationally, or logically, may be implemented by computer programs or equivalent electrical circuits, microcode, or the like. Furthermore, arrangements of operations may be referred to as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In some examples, a software module can be implemented with a computer-readable medium storing computer program code, which can be executed by a processor for performing any or all of the steps, operations, or processes described.

Some examples may relate to an apparatus or system for performing any or all of the steps, operations, or processes described. The apparatus or system may be specially constructed for the required purposes, and/or it may comprise a general-purpose computing device selectively activated or reconfigured by a computer program stored in memory of computing device. The memory may be or include a non-transitory, tangible computer readable storage medium, or any type of media suitable for storing electronic instructions, which may be coupled to a bus. Furthermore, any computing systems referred to in the specification may include a single processor or multiple processors.

While the present subject matter has been described in detail with respect to specific examples, it will be appreciated that those skilled in the art, upon attaining an understanding of the foregoing, may readily produce alterations to, variations of, and equivalents to such embodiments. Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure claimed subject matter. Accordingly, the present disclosure has been presented for purposes of example rather than limitation, and does not preclude the inclusion of such modifications, variations, and/or additions to the present subject matter as would be readily apparent to one of ordinary skill in the art.

For clarity of explanation, in some instances the present disclosure may be presented as including individual functional blocks including functional blocks comprising devices, device components, steps or routines in a method embodied in software, or combinations of hardware and software. Additional functional blocks may be used other than those shown in the figures and/or described herein. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Individual examples may be described herein as a process or method which may be depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but may have additional steps not shown. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc.

Devices implementing the methods and systems described herein can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. The program code may be executed by a processor, which may include one or more processors, such as, but not limited to, one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A processor may be a microprocessor; conventional processor, controller, microcontroller, state machine, or the like. A processor may also be implemented as a combination of computing components (e.g., a combination of a DSP and a microprocessor, a plurality of microprocessors, one or more microprocessors in conjunction with a DSP core, or any other such configuration). Accordingly, the term “processor,” as used herein may refer to any of the foregoing structure, any combination of the foregoing structure, or any other structure or apparatus suitable for implementation of the techniques described herein. Functionality described herein also can be embodied in peripherals or add-in cards. Such functionality can also be implemented on a circuit board among different chips or different processes executing in a single device, by way of further example.

In the foregoing description, aspects of the disclosure are described with reference to specific examples thereof, but those skilled in the art will recognize that the disclosure is not limited thereto. Thus, while illustrative examples of the disclosure have been described in detail herein, it is to be understood that the inventive concepts may be otherwise variously embodied and employed, and that the appended claims are intended to be construed to include such variations. Various features and aspects of the above-described disclosure may be used individually or in any combination. Further, examples can be utilized in any number of environments and applications beyond those described herein without departing from the broader spirit and scope of the disclosure. The disclosure and figures are, accordingly, to be regarded as illustrative rather than restrictive.

The various illustrative logical blocks, modules, circuits, and algorithm steps described in connection with the embodiments disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or media devices of the computing platform. The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology, its practical application, and to enable others skilled in the art to utilize the technology in various embodiments and with various modifications as are suited to the particular use contemplated. It is intended that the scope of the technology be defined by the claim.

What is claimed is:

1. A computer-implemented method of performing neighborhood-centric online searches, the method comprising:
receiving a request sent over a communication network from a user device associated with a user account registered with a geocentric platform server, the request concerning initiation of an exchange with an agent device associated with an agent account registered with the geocentric platform, wherein the request includes one or more objects;
querying one or more databases for data associated with the objects;
identifying one or more agent devices associated with the objects, wherein the agent devices are configured to provide the objects to the user device;
initiating the exchange between the user device and the agent devices, wherein the exchange includes a request to allocate the objects to the user device;
determining a resource to allocate to the user device based on a predetermined allocation schedule stored in a respective database, wherein the resource is based on the exchange between the user device and the agent devices; and
initiating transmission of the resource to the user device.

2. The computer-implemented method of claim 1, wherein the databases include a local database that stores available objects in association with respective agents.

3. The computer-implemented method of claim 2, further comprising:
receiving a notification that the local database is unable to retrieve data associated with a portion of the objects:
querying an external database associated with one or more third-party agent devices for the data associated with the portion of the objects; and
updating the local database with the data associated with the portion of the objects, wherein the data associated with the portion of the objects is stored in association with a local agent.

4. The computer-implemented method of claim 1, further comprising:
generating a display of an interactive user interface for the user device, the display including the data associated with the objects and one or more options for fulfilling the request to initiate the exchange; and
receiving an interaction via the interactive user interface of the user device indicating an option selected from among the options.

5. The computer-implemented method of claim 1, further comprising:
transmitting a notification to the agent devices that includes exchange data, information pertaining to the objects, and instructions to deliver the objects to the user device; and
facilitating delivery of the objects to the user device.

6. The computer-implemented method of claim 1, wherein the exchange includes a first object associated with a first agent device and a second object associated with a second agent device.

7. The computer-implemented method of claim 1, wherein the resource is an update of progress to achieve delivery of an incentive.

8. A system of performing neighborhood-centric online searches, the system comprising:
one or more processors;
a communication interface that communications over a communication network, wherein the communication interface receives a request sent from a user device associated with a user account registered with a geocentric platform server, the request concerning initiation of an exchange with an agent device associated with an agent account registered with the geocentric platform, wherein the request includes one or more objects; and
a memory that stores instructions executable by the one or more processors to:
query one or more databases for data associated with the objects;
identify one or more agent devices associated with the objects, wherein the agent devices are configured to provide the objects to the user device;
initiate the exchange between the user device and the agent devices, wherein the exchange includes a request to allocate the objects to the user device;
determine a resource to allocate to the user device based on a predetermined allocation schedule stored in a respective database, wherein the resource is based on the exchange between the user device and the agent devices; and
initiate transmission of the resource to the user device.

9. The system of claim 8, wherein the databases include a local database that stores available objects in association with respective agents.

10. The system of claim 9, wherein the communication interface further receives a notification that the local database is unable to retrieve data associated with a portion of the objects, and wherein the processors execute further instructions to:
query an external database associated with one or more third-party agent devices for the data associated with the portion of the objects; and
update the local database with the data associated with the portion of the objects, wherein the data associated with the portion of the objects is stored in association with a local agent.

11. The system of claim 8, wherein the processors execute further instructions to generate a display of an interactive user interface for the user device, the display including the data associated with the objects and one or more options for fulfilling the request to initiate the exchange, and wherein the communication interface further receives an interaction via the interactive user interface of the user device indicating an option selected from among the options.

12. The system of claim 8, wherein the communication interface further:
transmits a notification to the agent devices that includes exchange data, information pertaining to the objects, and instructions to deliver the objects to the user device; and
facilitates delivery of the objects to the user device.

13. The system of claim 8, wherein the exchange includes a first object associated with a first agent device and a second object associated with a second agent device.

14. The system of claim 8, wherein the resource is an update of progress to achieve delivery of an incentive.

15. A non-transitory computer-readable media storing instructions that, when executed by one or more processors, cause the one or more processors to perform a method comprising:
receiving a request sent over a communication network from a user device associated with a user account registered with a geocentric platform server, the request concerning initiation of an exchange with an agent device associated with an agent account registered with the geocentric platform, wherein the request includes one or more objects;
querying one or more databases for data associated with the objects;
identifying one or more agent devices associated with the objects, wherein the agent devices are configured to provide the objects to the user device;
initiating the exchange between the user device and the agent devices, wherein the exchange includes a request to allocate the objects to the user device;
determining a resource to allocate to the user device based on a predetermined allocation schedule stored in a respective database, wherein the resource is based on the exchange between the user device and the agent devices; and
initiating transmission of the resource to the user device.

16. The non-transitory computer-readable media of claim 15, wherein the databases include a local database that stores available objects in association with respective agents.

17. The non-transitory computer-readable media of claim 16, further comprising instructions executable to:
receive a notification that the local database is unable to retrieve data associated with a portion of the objects:
query an external database associated with one or more third-party agent devices for the data associated with the portion of the objects; and
update the local database with the data associated with the portion of the objects, wherein the data associated with the portion of the objects is stored in association with a local agent.

18. The non-transitory computer-readable media of claim 15, further comprising instructions executable to:
generate a display of an interactive user interface for the user device, the display including the data associated with the objects and one or more options for fulfilling the request to initiate the exchange; and
receive an interaction via the interactive user interface of the user device indicating an option selected from among the options.

19. The non-transitory computer-readable media of claim 15, further comprising instructions executable to:
transmit a notification to the agent devices that includes exchange data, information pertaining to the objects, and instructions to deliver the objects to the user device; and
facilitate delivery of the objects to the user device.

20. The non-transitory computer-readable media of claim 15, wherein the exchange includes a first object associated with a first agent device and a second object associated with a second agent device.
